(19) United States
(12) Patent Application Publication
(10) Pub. No.: US 2018/0018969 A1
(43) Pub. Date: Jan. 18, 2018

(54) Call Forwarding to Unavailable Party Based on Artificial Intelligence

(71) Applicant: CIRCLE RIVER, INC., New York, NY (US)

(72) Inventors: Adam Bentitou, New York, NY (US); David Mansfield, New York, NY (US); Robert Lippman, East Hampton, NY (US)

(21) Appl. No.: 15/211,120

(22) Filed: Jul. 15, 2016

(51) Int. Cl. G10L 17/10; G10L 15/26; G10L 17/02; H04M 3/54; G10L 25/63; G10L 15/08

(52) U.S. Cl. CPC G10L 17/10; H04M 3/54; G10L 25/63; G10L 15/26; G10L 17/02; G10L 2015/088

(57) ABSTRACT

A called party indicates that he or she is unavailable to receive a call. However, by way of a combination or any one of determining aspects of the who the caller is, where the caller is located, what he is speaking about, or the like as well as comparing this to prior calls, the call might be sent to a called party to be on the call. This can be by way of speech recognition of the call and creating a transcript and by receiving feedback from a called party about prior calls.

### FIELD OF THE DISCLOSED TECHNOLOGY

The disclosed technology relates generally to automated call answering and, more specifically, to conditional forwarding of calls.

### BACKGROUND OF THE DISCLOSED TECHNOLOGY

Sometimes a person wants to receive all of his or her calls. Sometimes he/she only wants to receive some of them. Some have secretaries to screen calls. Others find out only after taking the call that they didn't want accept it. Methods are needed to help called parties decide whether to take the incoming call or not.

### SUMMARY OF THE DISCLOSED TECHNOLOGY

The disclosed technology concerns when to forward a phone call to a called party. When the called party indicates that he/she is available, the call is sent to the called party in more instances than when the called party indicates that he/she is unavailable. In fact, being “unavailable,” for purposes of this disclosure, is defined as indicating a desire to, and/or sending instructions to, accept fewer phone calls than in an “available” state. The fewer phone calls accepted are based upon one or more parameters, such as only accepting urgent calls. Urgent calls or call urgency is determined based on factors described herein below. It should also be understood that “phone call” can refer to phone calls over a public switched telephone network, a private telephone network, and/or any method of sending/receiving audio between two devices. For purposes of this disclosure, “phone” is used to refer to all such instances.

In embodiments of the disclosed technology, a phone call is sent to a device associated with the called party, which is defined as a caller attempting to reach a particular person or entity associated by way of a direct inward dial number (DID), associated alias or user identification, or the like. The called party uses a bidirectional transceiver (a device which receives and sends electrical impulses whether wired or wireless), which is referred to together as the “called party,” meaning the person who controls, or is associated with, the device and/or DID or the like. The call directed to the called party is received at a network node where the calling party is determined based on one or both of call identification information or voice recognition. The call identification information can be provided as digital information out of band with the audio of the phone call (for example, the calling line identification or CallerID protocol, as well as the automatic number identification (ANI) protocol). Or the call identification information can be provided by the calling party during the phone call, such as being prompted for, and responding with, a name. Voice recognition can be used in conjunction there-with to match the calling party to previous calling parties.

A determination is then or previously made that the called party is unavailable, and this is indicated to the calling party via audio within the phone call. A further or prior conversation with the calling party ensues at the network node, such as with an interactive voice response (IVR) system known in the art, where a synthesized digital voice or pre-recorded voice interacts with the calling party. Urgency is detected in the voice of the calling party using voice recognition and determinations within the voice such as volume, change in volume, tone, speed, anger, keywords and other factors. Based on such urgency, in some embodiments of the disclosed technology, the call is forwarded to the called party despite the calling party indicating that he/she is unavailable. In other embodiments, even though urgency is detected the call is not forwarded to the bidirectional transceiver associated with the called party.

In some embodiments, an additional step of transcribing audio within the phone call, such as audio of the calling party/send by a device associated with the calling party (e.g., a bidirectional transceiver) is carried out. The text itself is used to determine urgency based on pre-designated keywords (e.g., “dead,” “death,” “school nurse,” etc.) in the text which indicates urgency. This can further be based on a combination of tone and speed of speech above a pre-defined threshold indicating urgency.

As described above, in some cases even when urgency is detected, the phone call is not forwarded to the called party. This can happen when the call identification information matches a pre-designated call identification information on a blacklist. Further, different calls can be compared to one another, so that, if any information related to a first phone call which was forwarded and the called party sent data/indicated a desired not to receive even “urgent” calls from the particular calling party, then this calling party is not forwarded to the called party in another phone call. This same calling party can be determined (and then denied forwarding) based on a voice recognition match or caller identification match, indicating it's the same calling party. The call being forwarded to the called party might also be denied due to a keyword in a transcript of phone call matching a negative keyword (e.g., “mistress,” “Belgium,” or “offer”).

An additional step of forwarding the call, which is a first call, to the bidirectional transceiver associated with said called party, based on the detecting of urgency, is carried out in embodiments. Then, data are received from the called party, indicating that the forwarding of the call was desired or undesired. These data can be in the form of entry into the bidirectional transceiver (DTMF tones (dual-tone multi-frequency signaling), responded to a displayed query on a display device with an input device such as touchscreen of the bi-directional transceiver, or the like). The data can also be in the form of making a determination based on the called party's voice (e.g., anger) determined as part of speech recognition, accelerometer report from the phone (e.g. throws the phone down versus gently places it back in his pocket), or length he/she remains on the call (e.g., hangs up after 10 seconds compared to an average call length of 10 minutes).

The aspects of the first and second call which might lead to comparing the two and making a determination as to whether to forward or not forward the second call can be one or more of grammar and/or syntax (does the person speak with proper American grammar, British grammar, ebonies, or some form of improper grammar), common keywords (e.g., both callers say an unusual word in the English language specific to the called party, such as “patent” to a patent attorney, which is learned as a desired word for forwarding the call), or the like. Further, location of the calling party, determined by callerID, ANI, or provided via speech during the course of the call, might be a determining factor to compare and do likewise for the second call as the first. Speaking tone and speaking speed may also be a factor (the called party may only want to accept calls when unavailable from female callers, even if he/she is unaware of this practice). Tonal and speed changes from a first time period in the call (e.g., beginning of the call) compared to a second time period (e.g., after second question presented to the calling party) may also factor into the comparison. The time until the calling party reaches the threshold of “urgent” in the call may also be a factor, such as if it took the first caller a minute into the call to reach the urgency threshold, and this was found to be an undesired forward to the called party, a maximum time for such urgent calls in the future is reduced.

Any device or step to a method described in this disclosure can comprise, or consist of, that which it is a part of, or the parts which make up the device or step. The term “and/or” is inclusive of the items which it joins linguistically and each item by itself.

### BRIEF DESCRIPTION OF THE DRAWINGS

FIG. 1 is a high level block diagram of devices which are used to carry out embodiments of the disclosed technology.

FIG. 2 is a high level flow chart depicting how calls are forwarded to a called party when they are urgent, in embodiments of the disclosed technology.

FIG. 3 is a high level flow chart which depicts further aspects of determining urgency, in embodiments of the disclosed technology.

FIG. 4 shows a high-level block diagram of a device that may be used to carry out the disclosed technology.

### DETAILED DESCRIPTION OF EMBODIMENTS OF THE DISCLOSED TECHNOLOGY

A called party indicates that he or she is unavailable to receive a call. However, by way of a combination or any one of determining aspects of who the caller is, where the caller is located, what he is speaking about, or the like, as well as comparing this to prior calls, an alert might be sent to a called party to join in the call. This can be by way of speech recognition of the caller and creating a transcript, and by receiving feedback from a called party about prior calls. For purposes of this disclosure, “speech recognition” is defined as “making a determination of words exhibited aurally.” Further, “voice recognition” is defined as “making a determination as to who is the speaker of words.”

Embodiments of the disclosed technology are described below, with reference to the figures provided.

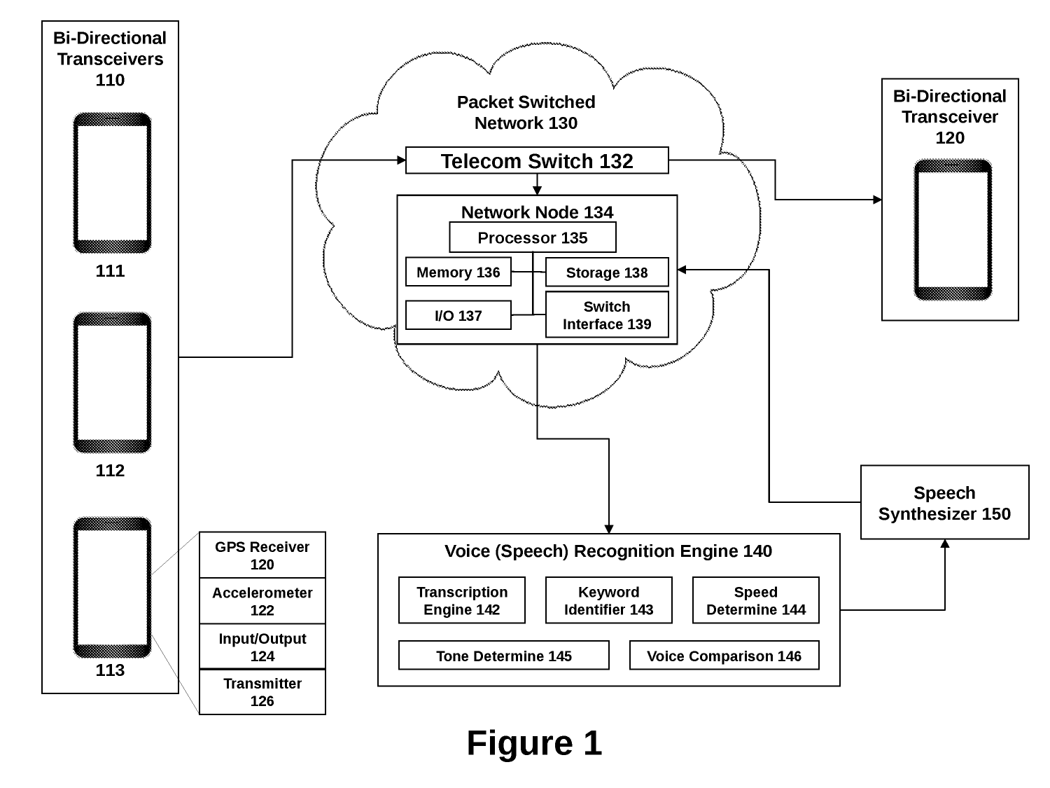

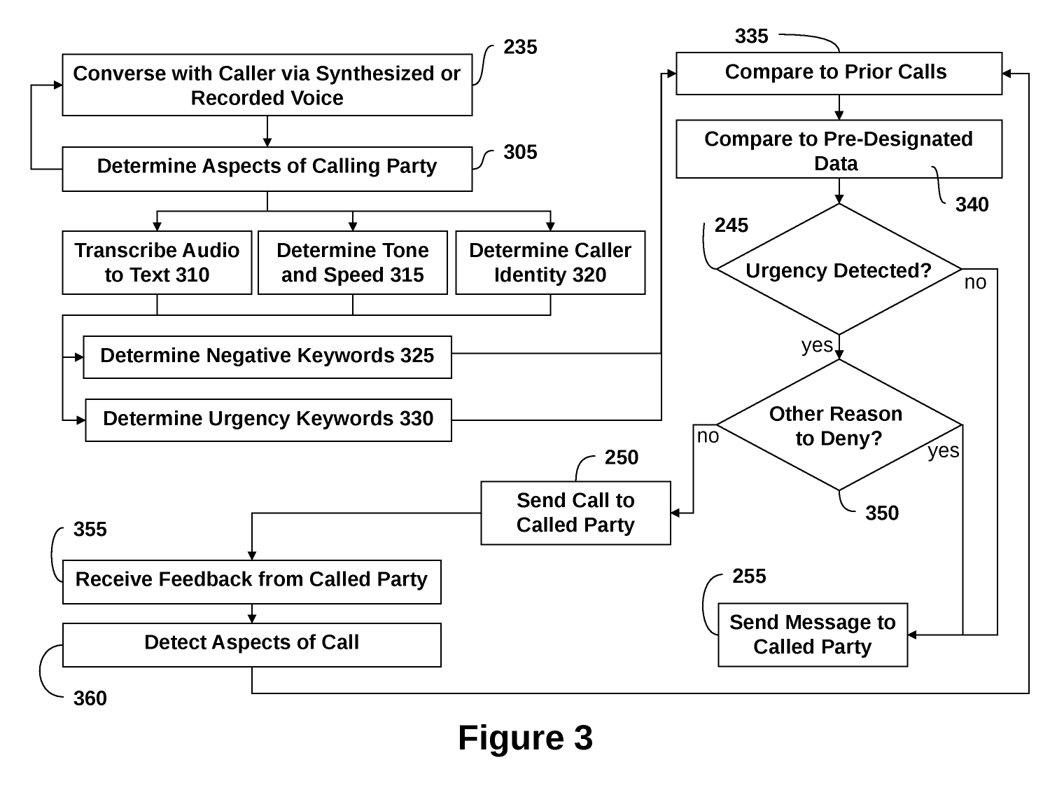

FIG. 1 is a high level block diagram of devices which are used to carry out embodiments of the disclosed technology. A plurality of bi-directional transceivers 110 associated with calling parties is shown. Typically, a call is placed from one calling party 110 (represented by one of the phones 111, 112, or 113), with an intent to reach an entity associated with a receiving device, such as a bi-directional transceiver 120, which is the called party. The reason for showing multiple calling parties will become apparent when discussing FIG. 3, below, where aspects of prior calls are compared to determine if a call should be considered urgent and/or forwarded to the called party. This call/these calls can be over a regular phone line or phone network and have aspects or parts of the call which are wired or wireless. The called party can be a particular person operating the device 120 or any one of a group of people, such as an employee of a company being called by a calling party 110. In some embodiments of the disclosed technology, the called party is any live human being who is conversing via the telecommunications switch 132, and the network node 134 is any non-live person or synthesized speech from text (e.g., “artificial intelligence”) doing likewise. One or more of the bi-directional transceivers can have some or all of the following elements: a GPS (Global Positioning System) receiver 120, an accelerometer 122, input/output mechanisms 124, and a transmitter 126.

The GPS receiver 120 is a global positioning system receiver which receives data from global navigation satellites to determine location and reports this location information. This can be used to accept/deny calls or determine if a called party is available or unavailable, based on his/her location or based on the location of the calling party. The accelerometer 122 measures acceleration and, indirectly, distance, based on time at a rate of acceleration. This can be used, for example, when a called party 120 slams down the phone after a call to determine that the call should not have been passed to the called party. Other location determination devices which can be used include the Internet protocol (IP address) of one of the bi-directional transceivers 110 and/or 120, and looking up a location associated with a number reported by the calling line identification (caller ID) or ANI (automated number identification) protocols.

The input/output 124 refers to a keyboard, touch screen, display, and the like, used to receive input from, and send output to, a user of the device. A transmitter 126 enables wireless transmission and receipt of data via a packet-switched network, such as packet-switched network 130. This network, in embodiments, interfaces with a telecommunications switch 132 which routes phone calls and data between two of the bi-directional transceivers 110 and 120. Versions of these data, which include portions thereof, can be transmitted between the devices. A “version” of data is that which has some of the identifying or salient information, as understood by a device receiving the information. For example, audio converted into packetized data can be compressed, uncompressed, and compressed again forming another version. Such versions of data are within the scope of the claimed technology, when audio or other aspects are mentioned.

Referring again to the telecom switch 132, a device and node where data are received and transmitted to another device via electronic or wireless transmission, it is connected to a network node 134, such as operated by an entity controlling the methods of use of the technology disclosed herein. This network node is a distinct device on the telephone network, which sends and receives data to the telephone network, or another network which carries audio or versions of data used for creating, or were created from, audio. At the network node is a processor 135 deciding when the bi-directional transceivers 110 and 120 can communicate with each other via audio, such as by forwarding the call from a transceiver 110 to a transceiver 120. At the network node 134 is also memory 136 (volatile or non-volatile) for temporary storage of data, storage 138 for permanent storage of data, and input/output 137 (like the input/output 124), and an interface 139 for connecting via electrical connection to other devices.

Still discussing FIG. 1, a voice or speech recognition engine 140 is used. This is a device which receives audio input, detects speech and can do any one or a multiple of things with speech such as transcribing the speech into text with a transcription engine 142, identifying keywords in the text with a keyword identifier 143, determining the speed of the speech (144) over the course of the audio, determining the tone of the audio (145), and determining whose voice the audio belongs to by comparing the voice to previous calls (146). In this manner, aspects of the audio and, therefore, aspects of the call are determined. Based on this, a speech synthesizer 150 is used, in embodiments of the disclosed technology, to communicate back over an audio channel (such as on a phone call) with the caller. In other embodiments, recorded voices can be used instead of, or in conjunction with, the synthesized speech.

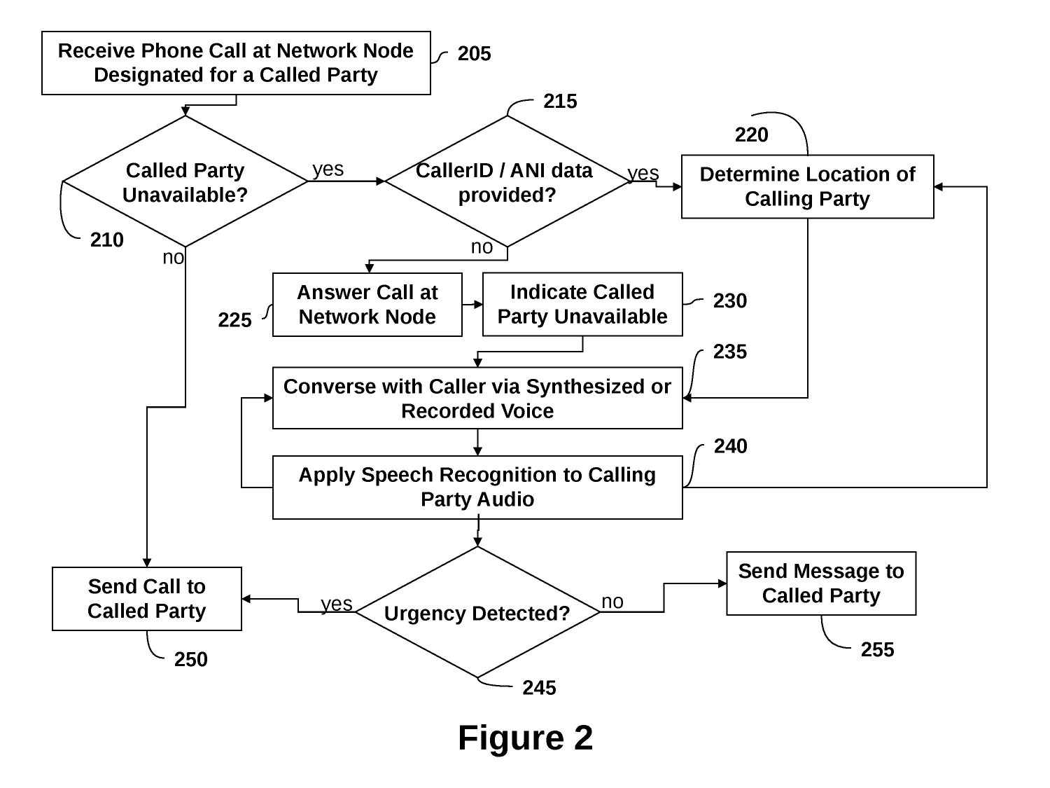

FIG. 2 is a high level flow chart depicting how calls are forwarded to a called party when they are urgent, in embodiments of the disclosed technology. In step 205, a phone call is received at a network node designated for a called party. The definitions and descriptions of who the called party can be are described with reference to FIG. 1. A determination is then made, in step 210, if the called party is unavailable. See the definition of “unavailable” in the summary of the disclosed technology. Further, unavailable status can be determined by receiving an indication of same from a called party (such as by way of his/her receiver 120), by his/her not answering a phone call, by GPS reporting on his/her device that the device is at a location or outside of a geo-fenced area where he/she becomes unavailable, and the like. For example, the called party may only be available when at work, but when going home and leaving proximity to work, he/she may want to be “unavailable” to regular calls.

If the called party is available, the call is simply sent to the called party in step 250, by way of his/her device (e.g., his/her phone or bidirectional transceiver 210). If not, then it must be determined if the call should be sent to the called party anyway. In order to do this, a plethora of factors can be taken into account. That is, any one, a combination of, or plurality of the factors and concepts discussed in the summary, and from this point through the rest of the “detailed description” can be used to send a call to a called party who is unavailable. Before or after answering the call, callerID or ANI data is checked. This may, in step 220, help determine the location of the calling party, which can be a factor in forwarding the call. For example, international calls can be sent to the called party even when he/she is “unavailable. Or the data can match a person on a “whitelist” and thus be forwarded to the called party. Before of after this determination, the call is answered at a network node, in step 225. In some embodiments, an indication is made to the calling party (in step 230) that the called party is unavailable. In other embodiments, the calling party does not receive an indication as such, but in any case, the method proceeds with step 235, where a synthesized or recorded voice is used to converse with the calling party. Speech recognition is applied, in step 240, to determine what is being said and transmitting in the call by the calling party.

In step 245, a conversation might take place to determine if the call is urgent. So describing steps 235, 240, and 245 a conversation via a synthesized voice (text to speech) or recorded voice, played at the appropriate time during the call, might look something like this:

Synthesized voice: “I'm sorry, but Mr. Lippman is unavailable. Is this an urgent matter?”

Calling Party: “Yes, it is!”

Synthesized voice: “Please tell me why it's urgent.”

Calling Party: “I can't find the cat food, and the cat needs to eat!”

Synthesized voice: “Who is this, by the way?”

Calling Party: “It's Mr. Lippman's son.”

Synthesized voice: “Okay, let me see if Mr. Lippman wants to answer the call.”

During this conversation, or in other embodiments, before or after the conversation with the synthesized or recorded voice, step 220 can be carried out to determine the location of the calling party, as described above. Thus, Mr. Lippman's son might be determined as being the caller based on voice recognition (comparing the voice to previous calls with “son”), his location (comparing to prior locations when the son called and/or limiting the location when it is believed to be the son to calls from a certain area code or area codes that Mr. Lippman has previously designated as where his “family” might be calling from), or the like. In this case, urgency might also be detected based on certain keywords such as “son” or “cat.” Mr. Lippman might want all calls from his son to be detected as urgent, so that the call might be detected as “urgent” as soon as the calling party says “Yes, it is!” or makes another recognizable utterance determined to be from a specific calling party. Or, in another embodiment, a negative keyword such as “cat” may be used. Thus, if someone says “cat,” the call will be considered non-urgent because Mr. Lippman doesn't want to be interrupted to talk about the cat when he is unavailable, as determined in step 210.

In any of the above cases, once urgency is detected in step 245, the call is sent to the called party in step 250, such as to a device associated with the called party or under the direct operative control of the called party, such that, the called party can exchange audio with the calling party in the phone call. If urgency is not detected then the called party is sent a message in step 255. This message can be during the phone call or after the phone call, and in the form of a text or voice message having a version of the audio from a portion of the call.

FIG. 3 is a high level flow chart which depicts further aspects of determining urgency, in embodiments of the disclosed technology. Here, steps numbered in the 200s are the same as the steps shown and described with respect to FIG. 2. Thus, in step 235, the caller converses with the synthesized or recorded voice. While this step takes place, aspects of the calling party are determined in step 305 in a continuous loop, in embodiments of the disclosed technology. These aspects include one or a combination of the following. One such aspect is the grammar and/or syntax of the calling party. Does the syntax indicate correctly spoken English (or another language)? Does the syntax indicate a person from a certain geographic area? Other aspects of grammar and syntax detection can include a type of grammar or syntax used by those in urgent situations, such as louder voices, shorter sentences, or an otherwise excited state of speech which is detected. Syntax comprising or consisting of semantic content which denotes an emergency is also considered. Other aspects can be based on questions such as does the syntax match that of a prior caller? Was this prior caller, who was forwarded to the called party, wanted by the called party, or did the called party indicate that the call should not have been forwarded. This is shown in step 355, where feedback is received from the called party about a call he or she received, this feedback being explicit (such as by answering a query sent to the device of the called party) or implicit (by hanging up the call quickly, whether “quickly” is by way of time or by way of acceleration of the device from the called party's ear downward, as detected by an accelerometer).

Another aspect of the calling party can be keywords used by the calling party during the call. Speech recognition and transcription of the call (step 310) can be used to find these keywords (steps 325 and 330) and can be taken into consideration when deciding whether to forward or not forward the call (which happens upon detection of urgency). This is described with reference to FIG. 2, with the examples of “son” and “cat” in more detail. Another aspect of the call, also described above, is the caller identification information (step 320). The caller is identified based on CallerID information, recognizing the caller's voice as being that of a previous caller, or the like. Such information can also be used to determine the location of the calling party and then, based on their location, deem the call urgent or not urgent. The location or identity of the calling party can also be determined simply by asking the calling party to state, during the phone call, his or her location or name. If the location is within a certain distance to another denied call or another call determined to be urgent, then the call might or might not be sent to the called party who is unavailable.

In step 315, the tone or speed the caller's speech can also be used to determine urgency. An urgent caller might speak in a higher pitch or speed, above a pre-designated threshold. A tonal change between a first and second time period during a call can also be used to determine urgency. For example, a caller may speak fast at first, but, after being prompted with a question, speak more slowly, versus another caller who continues to speak just as fast or at the same tone as previously. With all of these aspects, prior calls which were determined to be urgent can be compared with a present call to determine if the call is urgent, and feedback (step 355) from a called party can be used to make such determinations. The feedback from a particular called party might apply for future calls to that called party, or to any called party where a network nodes carries out aspects of the disclosed technology.

Still other aspects of the call in step 305 can include the sex of the caller (a particular called party may decide that calls from females should get through even if he's “unavailable” for example), or this may be decided based on his past habits, and/or based on the outcome of other calls and/or his feedback in step 355. Another aspect is time on the call until urgency is detected. Again, this can be used as a function to compare to later calls which take just as long, depending on how the called party reacted to the call. For example, if the call goes on for two minutes before “fire” is detected, perhaps this call isn't urgent, whereas if it is said in the first 10 seconds or during the first or second answer to a query, then it is urgent.

Thus, as described above, once aspects of the calling party are determined in step 305, including aspects of the speech and characteristics thereof, such as shown in steps 310 through 330, these aspects are compared to prior calls in step 335 of embodiments of the disclosed technology. This is also, or instead, compared to pre-designated or entered data in step 340, in some embodiments of the disclosed technology. For example, see the above discussion about a maximum time frame for the call until urgency is detected—this maximum time frame can be determined based on pre-designated data indicating a maximum time, or by determining this from where prior calls were found to be urgent, and/or confirmed to be urgent by the particular called party being called now, or a plurality of different called parties using the system. Based on this, urgency can be detected in step 245, in which case even when urgency is detected, the call can be denied in step 350, due to one of the aspects of the calling party or speech within the call, as described above. If the call to the called party is still denied in step 350, or urgency is not detected, then step 255 is carried out, and a message is sent to the called party, as described with reference to step 255 in FIG. 2. The calling party, in some embodiments, is notified that his or her call has been deemed non-urgent. In other embodiments, no such notification is given, and the call simply ends after a message is left for the called party, or a notification is given that the call is ending.

Note that in step 335, where the prior calls are compared, this can be based on feedback from the called party being called, or other called parties in other calls, in step 355. In some embodiments, the called party is prompted after sending the message to the called party in step 255, or the call to the called party ends after step 250. A query, whether by audio or visually, exhibited, is sent to the calling party, asking, “Should this call have been sent to you despite your unavailable status?” (Obviously, any like-kind query can be made requesting whether or not the called party wanted to receive the call.) The called party can then respond positively or negatively, and, in some embodiments, why this is so. These answers can then be taken into account when comparing prior calls in step 335, based on like-kind aspects of a prior call and a present call, such as any of the aspects described above or determined in step 305. In some cases, the called party might be asked a further question, such as, “is it because this was a family member that you wanted to receive the call?” or another question based on an aspect of the call which was determined. As such, confirmation of an aspect of the call which is important or non-important to the called party can be determined. Another such query might be, “this person said ‘cat’ during the call. Is that a subject worth sending you calls about if you are unavailable?” Thus, a keyword can be used for future calls based on the called party's desires about the keyword, or the system can simply determine same by a rejection of a prior call in which the term was used.

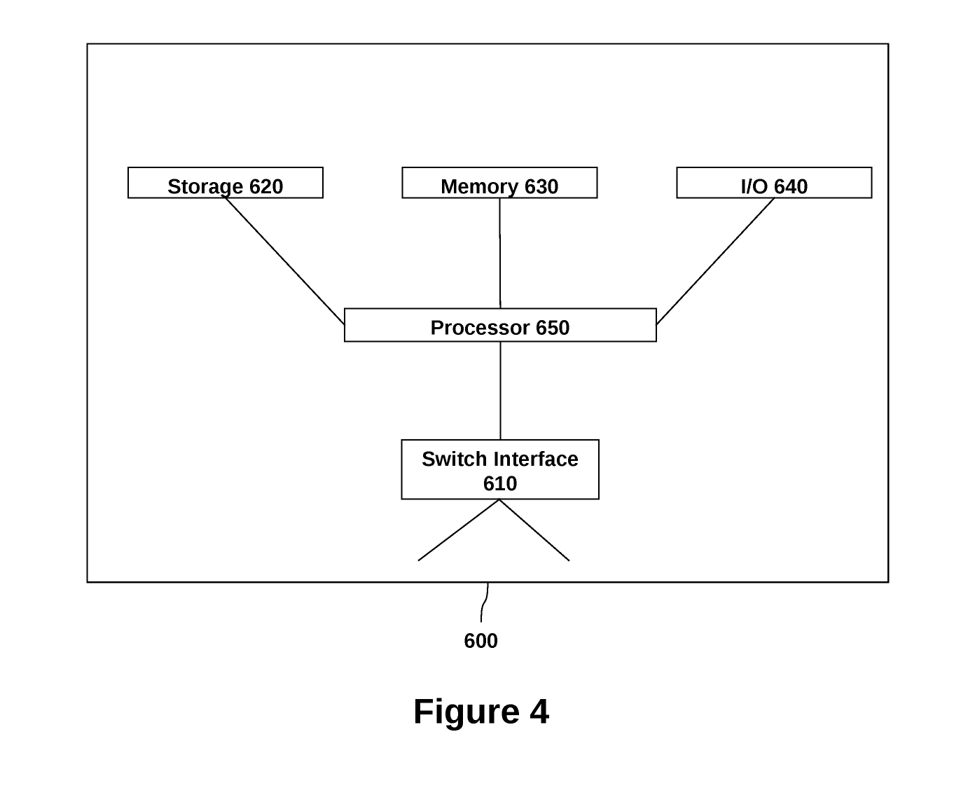

FIG. 4 shows a high-level block diagram of a device that may be used to carry out the disclosed technology. Device 600 comprises a processor 650 that controls the overall operation of the computer, by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions. A device 600 also includes one, or a plurality of, input network interfaces for communicating with other devices via a network (e.g., the internet). The device 600 further includes an electrical input interface. A device 600 also includes one or more output network interfaces 610 for communicating with other devices. Device 600 also includes input/output 640 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device, for illustrative purposes. It should also be understood by one skilled in the art that the method and devices depicted in FIGS. 1 through 3 may be implemented on a device such as is shown in FIG. 4.

Further, it should be understood that all subject matter disclosed herein is directed and should be read only on statutory, non-abstract subject matter. All terminology should be read to include only the portions of the definitions which may be claimed. By way of example, “computer readable storage medium” is understood to be defined as only non-transitory storage media.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A method of conditionally forwarding a received phone call to a bidirectional transceiver associated with a called party, comprising the steps of:
receiving said phone call at a network node, said phone call directed towards a called party;
determining an identity of a calling party based on at least one of call identification information, voice recognition, and speech recognition;
determining that said called party is unavailable;
detecting urgency in a voice of said calling party based on content, as determined by speech recognition, of said phone call originating from said calling party;

2. The method of claim 1, comprising an additional step of forwarding said call to said bidirectional transceiver associated with said called party based on said detecting of urgency.

3. The method of claim 2, further comprising a step of transcribing into text said audio within said phone call originating from said calling party; and
wherein said step of detecting urgency is based on a keyword within said text which has been pre-designated as a keyword which indicates said urgency.

4. The method of claim 2, wherein said step of detecting urgency is further based on a combination of tone and speed of speech above a pre-defined threshold indicating said urgency.

5. The method of claim 1, wherein:
urgency is detected in said voice of said calling party and said call;
a request from said calling party for the call to be sent to said calling party is denied based on said call identification information matching pre-designated call identification information.

6. The method of claim 1, comprising an additional step of forwarding said call to said bidirectional transceiver associated with said called party based on said detecting of urgency is carried out at least a first time; and
receiving data from said called party indicating that when said called party is unavailable calls from said calling party with said urgency in said voice, and denying forwarding of a subsequent call from said calling party to said called party when said called party is unavailable.

7. The method of claim 6, wherein said subsequent call is determined to be from said calling party based on a match of voice recognition in said subsequent call and said call, where said call was forwarded to said bi-directional transceiver associated with said called party.

8. The method of claim 6, wherein said subsequent call is determined to be from said calling party, based on a match of caller identification information in said subsequent call and said call, where said call was forwarded to said bidirectional transceiver associated with said called party.

9. The method of claim 1, further comprising a step of transcribing into text said audio within said phone call originating from said calling party;
urgency is detected in said voice of said calling party and said call; and
a request from said calling party for the call to be sent to said calling party is denied, based on a detected keyword in said text transcribed from audio of said calling party.

10. The method of claim 1, comprising an additional step of forwarding said call to said bidirectional transceiver associated with said called party, based on said detecting of urgency;
receiving data from said called party indicating that said forwarding of said call was desired or undesired;
forwarding, or denying forwarding of a second call from a second calling party based upon aspects of said second call which correspond to a first said call which was forwarded to said bidirectional transceiver associated with said called party.

11. The method of claim 10, wherein said comparable aspects are grammar and syntax, as determined by using speech recognition and transcription of said first call and said second call.

12. The method of claim 10, wherein said comparable aspects are keywords in said call, as determined by using speech recognition and transcription of said first call and said second call.

13. The method of claim 10, wherein said comparable aspects are location proximity, as determined based on said call identification information of said first call and said second call.

14. The method of claim 13, wherein said call identification information is selected from the group consisting of callerID and ANI and comprises a further lookup in a database to determine a location of said calling party based on said callerID or ANI information.

15. The method of claim 10, wherein said comparable aspects are location, as determined based on prompting each said calling party for same during each said phone call, and comparing a distance of each said location to each other.

16. The method of claim 10, wherein said comparable aspects are speaking tone and speaking speed, as determined by using speech recognition.

17. The method of claim 10, wherein said comparable aspects are tonal changes between a first and second time period during each respective said first call and said second call.

18. The method of claim 10, wherein said comparable aspects are sex of respective said calling parties, as determined by using speech recognition for said first call and said second call.

19. The method of claim 10, wherein said comparable aspects are time in respective said calls, until said urgency is detected in said first call and said second call.

20. The method of claim 10, wherein, after said step of determining that said called party is unavailable, indicating same to a calling party via audio within said phone call.

21. The method of claim 2, wherein said step of detecting urgency is further based on grammar and syntax of a transcription of said content of said phone call.
